(19) United States
(12) Patent Application Publication
(10) Pub. No.: US 2026/0327476 A1
(43) Pub. Date: Oct. 22, 2026

(54) CHEMICAL CONSOLIDATION OF THERMALLY CONDUCTIVE SLURRY IN GEOTHERMAL DOWNHOLE ENVIRONMENTS

(71) Applicant: XGS Energy, Inc., Palo Alto, CA (US)

(72) Inventors: Axel-Pierre Bois, Curis-au-Mont-D’Or (FR); Denise Nicole Benoit, Houston, TX (US); Simon James, Le Plessis-Robinson (FR); Rym Bouchair, Caluire et Cuire (FR); Aurelien Bouhours, Caluire et Cuire (FR)

(73) Assignee: XGS Energy, Inc., Palo Alto, CA (US)

(21) Appl. No.: 19/647,405

(22) Filed: Apr. 14, 2026

Related U.S. Application Data
(60) Provisional application No. 63/790,623, filed on Apr. 17, 2025.

(51) Int. Cl. C09K 8/467; C04B 14/02; C04B 28/10; C04B 103/00; C04B 111/00; E21B 33/13

(52) U.S. Cl. CPC C09K 8/467; C04B 14/024; C04B 28/105; E21B 33/13; C04B 2103/0079; C04B 2111/00146; C04B 2201/32

(57) ABSTRACT

A pumpable thermal reach enhancement (TRE) suspension is provided that comprises a mixture of a plurality of suspended TRE particles, water, and a water scavenging, gelling, or strengthening additive to allow for chemical consolidation of the TRE particles to so form a resulting chemically consolidated TRE sheath with a thermal conductivity of at least 1 W/mK and/or a compressive strength of at least 0.5 psi.

This application claims priority to US Provisional Patent Application with the Ser. No. 63/790,623, which was filed Apr. 17, 2025, and which is incorporated by reference herein.

### FIELD OF THE INVENTION

The field of the invention is compositions and methods of chemically consolidating a plurality of thermal reach enhancement (TRE) particles to so form a chemically consolidated TRE sheath, especially as it relates to filling the annular space between a wellbore and a closed loop geothermal harvesting system.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Closed-loop geothermal energy production relies on efficient heat transfer from a geological formation to a working fluid circulated through a closed-loop heat harvester in a wellbore. As a result, ensuring efficient thermal conductivity between the wellbore and the surrounding geological formation is critical for effective heat extraction.

Various methods have been explored that utilize thermally conductive materials within a wellbore to improve heat transfer from a geological formation to a working fluid of a closed-loop heat harvester. Conventional approaches often contain significant amounts of curable materials (e.g., cementitious materials) for strengthening of a grout mixture. Unfortunately, many of these curable materials do not exhibit high-thermal conductivity, which leads to a significant portion of the grout composition lacking thermal conductivity at best, or acting as an insulator at worst, even when the grout composition contains some thermally conductive materials.

Other known approaches for improving heat extraction utilize settling and hydraulic consolidation of thermally conductive materials within the wellbore. However, such methods of consolidation can be time-consuming, sometimes requiring long periods of time to achieve optimal packing, stability, and thermal properties. Consequently, the slow consolidation rate limits operational efficiency and delays heat harvesting capabilities.

Thus, even though various compositions and methods of geothermal heat transfer are known in the art, all or almost all of them suffer from several drawbacks, particularly where the material lacks a high thermal conductivity and lacks a high compressive strength. Therefore, there remains a need for compositions that exhibit improved consolidation speed, thermal conductivity, and mechanical strength.

### SUMMARY OF THE INVENTION

The inventive subject matter is directed to compositions and methods of chemically consolidating a plurality of thermal reach enhancement (TRE) particles, where consolidating additive is activated at the target location to reduce porosity and increase contact between the TRE particles, thereby improving thermal conductivity and mechanical strength of the compacted TRE sheath in the annular space of a geothermal wellbore. In especially contemplated aspects, the chemically consolidated material will produce a partially dehydrated, viscoplastic, or strengthened TRE sheath.

For example, in one aspect of the inventive subject matter, the inventors contemplate a pumpable thermal reach enhancement (TRE) suspension that includes a mixture comprising a plurality of suspended TRE particles, water, and a water scavenging additive, wherein the water scavenging additive is present in the mixture in an amount that allows for chemical consolidation of the mixture to form a partially dehydrated TRE sheath having a thermal conductivity of at least 1 W/mK, and wherein chemical consolidation comprises the water scavenging additive reacting with water in situ at a temperature above 50° C. to decrease porosity of the mixture and thereby form the partially dehydrated TRE sheath.

In some embodiments, the water scavenging additive reacts with water in situ at a temperature between 50° C. and 90° C. and accounts for between 0.1 and 50 wt % of a total weight of the mixture. Most typically, water accounts for between 0.5 and 70 wt % of a total weight of the mixture prior to the water scavenging additive reacting with the water in situ. After the water scavenging additive reacts with the water in situ, the water accounts for between 0.1 and 60 wt % of a total weight of the mixture. Where desired, the water further comprises a viscosity modifier. The viscosity modifier may break or thin in situ during heating at or above 90° C.

Water Preferably, but not necessarily, the water scavenging additive is an oxide or hydroxide particle selected from the group comprising magnesium oxide, titanium oxide, manganese oxide, iron oxide, copper oxide, aluminum oxide, periclase, lime, manganosite, bunsenite, zincite, bromellite, tenorite, brucite, portlandite, pyrochroite, theophrastite, sweetite, behoite, and spertiniite. In some embodiments, the water scavenging additive is selected from a group containing organic materials, polymeric materials, dendritic materials, zeolites, natural materials, or carbon-based materials. In other embodiments, the water scavenging additive is an inorganic material, a metal, a composite alloy, a mineral, or a ceramic.

As will be readily appreciated, the water scavenging additive reduces the fluidity of the TRE suspension and improves the packing efficiency of the TRE particles by at least 5%. In various embodiments, the water scavenging additive imparts improved mechanical properties to the partially dehydrated TRE sheath. Most typically, the TRE sheath has after chemical consolidation a final porosity of equal or less than 70% and/or has a permeability of equal or less than 1 centiDarcy.

Viewed from a different perspective, the inventors additionally contemplate a pumpable thermal reach enhancement (TRE) suspension that includes a mixture comprising a plurality of suspended TRE particles, water, and a gelling additive. It is generally contemplated that the gelling additive is present in the mixture in an amount that allows for gelation of the water or the mixture to form a viscoplastic TRE sheath having a thermal conductivity of at least 3 W/mK, and wherein gelation comprises the gelling additive reacting with water in situ at a temperature above 50° C. to increase the yield point of the water or the mixture and thereby form the viscoplastic TRE sheath.

In some embodiments, the gelling additive accounts for between 0.1 and 50 wt % of a total weight of the mixture. Most typically, the water accounts for between 0.5 and 70 wt % of a total weight of the mixture prior to the gelling additive reacting with the water in situ.

Preferably, but not necessarily, the gelling additive is an inorganic or polymeric gelling agent selected from the group consisting of bentonite, sepiolite, attapulgite, laponite, natural gelling polymers, modified natural polymers, synthetic polymers, and biopolymers.

Viewed from yet another perspective, the inventors further contemplate a pumpable thermal reach enhancement (TRE) suspension that includes a mixture comprising a plurality of suspended TRE particles, water, and a strengthening additive. Most typically, the strengthening additive is added to the mixture in an amount that allows for strengthening of the mixture to form a strengthened TRE sheath having a thermal conductivity of at least 1 W/mK and a compressive strength of at least 0.5 psi. Strengthening involves the strengthening additive reacting with water in situ at a temperature above 50° C. to increase compressive strength of the mixture and thereby for the strengthened TRE sheath.

In some embodiments, the strengthened TRE sheath has a compressive strength of between 0.5 psi and 500 psi. It is generally contemplated that the strengthening additive accounts for between 0.1 and 50 wt % of a total weight of the mixture. Whereas the water accounts for between 0.5 and 70 wt % of a total weight of the mixture prior to the strengthening additive reacts with the water in situ. After the strengthening additive reacts with the water in situ, the water accounts for between 0.1 and 60 wt % of a total weight of the mixture.

Preferably, but not necessarily, the strengthening additive is an inorganic cement or organic resin. In various embodiments, the strengthening additive improves the compressive strength of the TRE sheath by at least 0.5 psi. In other embodiments, the strengthening additive reduces the fluidity of the TRE suspension such that the strengthened TRE sheath has a final porosity of equal or less than 70% and/or has a permeability of equal or less than 1 centiDarcy.

In all perspectives discussed above, it is contemplated that a weight ratio of the TRE particles to the water scavenging, gelling, or strengthening additives is between 10:1 and 1:1. In some embodiments, the partially dehydrated, viscoplastic, or strengthened TRE sheath has a thermal conductivity of between 1 W/mK and 150 W/mK and/or has a compressive strength of greater than 0.5 psi.

In all perspectives discussed above, it is preferable that the TRE particles comprise a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy. In various embodiments, the TRE particles have a shape selected from the group consisting of a platelet, a flake, a sphere, an irregular shape, a cube, a rod, and a disc. In other embodiments, a first portion and a second portion of the plurality of TRE particles have a shape selected from the group consisting of a platelet, a flake, a sphere, an irregular shape, a cube, a rod, a disc, wherein the shape of the first and second portions are distinct.

In all perspectives discussed above, it is generally contemplated that the TRE particles have a D50 particle size of between 5 μm and 5.0 mm, and/or that the TRE particles have a D50 particle size of between 0.01 μm and 50 mm. In some embodiments, the TRE particles have a composition and shape such that a mass of the first particles, upon dehydration or gelation, can deform elastically or plastically.

Viewed from another perspective, the inventors additionally contemplate a method of placing a high-thermal reach enhancement (TRE) sheath around a closed-loop working fluid that is disposed in a wellbore at a target location within a geological formation that includes a step of pumping the suspension provided in the perspectives above into an annular space of the wellbore, wherein the annular space exists between the closed-loop working fluid casing and a wellbore wall at the target location, wherein the target location has a geostatic temperature sufficient for chemical consolidation, gelation, or strengthening of the suspension, and waiting for a time sufficient for dehydration, gelation, or strengthening of the suspension around the closed-loop working fluid casing to thereby form the TRE sheath.

Preferably, but not necessarily, the step of pumping the suspension and/or the step of waiting are repeatedly performed until the TRE sheath covers at least 10% of a vertical height of the casing. Most typically, the TRE sheath has a thermal conductivity of between 1 W/mK and 150 W/mK.

In some embodiments, the target location is at a depth of between 150 m and 20,000 m and extends in a substantially vertical orientation. In other embodiments, the target location has a geostatic temperature of between 120° C. and 600° C. It is generally contemplated that the wellbore is located in a greenfield, in a brownfield, is a disused or abandoned oil well, or is a disused or abandoned gas well and that the target location comprises hot dry igneous or metamorphous rock.

Where desired, the casing will have a vertical length of between 10 m and 10,000 m. In various embodiments, the TRE sheath is formed within 72 hours around the casing and covers between 10% and 100% of a perimeter of the casing. Most typically, the TRE sheath will have a vertical length of between 5% and 100% of a total length of the casing.

In some embodiments, the target location further includes a plurality of thermal reach enhancement (TRE) structures that are at least partially filled with a high-thermal conductivity material, and wherein the high-thermal conductivity material in the TRE structures is thermally coupled with the TRE sheath in the wellbore. It is generally contemplated that the TRE structures have a wedge-shaped configuration in which a mouth of the TRE structures is wider than a distal end of the TRE structures and the TRE structures are partially filled with the TRE sheath.

Viewed from an additional perspective, the inventors contemplate a system for heat transfer from a geological formation to a heat harvester casing, that includes a heat harvester casing disposed in a wellbore that descends from a topside location to a target location in a geological formation, a chemically consolidated TRE sheath thermally coupled the casing to a wall of the wellbore, wherein the chemically consolidated TRE sheath comprises a plurality of TRE particles, water, and an additive, wherein the additive reacts with water in situ at a temperature above 50° C. to form the chemically consolidated TRE sheath, and wherein the TRE particles in the chemically consolidated TRE sheath form a contiguous network of compacted material thermally coupling the casing with a wall of the wellbore.

In some embodiments, the chemically consolidated TRE sheath has a thermal conductivity of between 1 W/mK and 50 W/mK. In various embodiments, the chemically consolidated TRE sheath has a compressive strength of at least 0.5 psi. Most typically, the target location is at a depth of between 150 m and 20,000 m and extends in a substantially vertical orientation. Preferably, but not necessarily, the target location has a geostatic temperature of between 120° C. and 600° C. It is generally contemplated that the wellbore is located in a greenfield, in a brownfield, is a disused or abandoned oil well, or is a disused or abandoned gas well and that the target location comprises hot dry igneous or metamorphous rock.

In other embodiments, the target location further includes a plurality of thermal reach enhancement (TRE) structures that are at least partially filled with a first high-thermal conductivity material, and wherein the high-thermal conductivity material in the TRE structures is thermally coupled with the partially dehydrated TRE sheath in the wellbore. In such embodiments, the TRE structures extend from the wellbore distally into the geological formation at the target location and extend from the wall of the wellbore at least 1 m into the target location. Most typically, the TRE structures have a wedge-shaped configuration in which a mouth of the TRE structures is wider than a distal end of the TRE structures. Preferably, but not necessarily, the TRE structures are partially filled with the partially dehydrated TRE sheath.

Where desired, the additive may comprise at least one of a water scavenging additive, a gelling additive, and a strengthening additive. In some embodiments, the additive may comprise at least two of a water scavenging additive, a gelling additive, and a strengthening additive.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A-FIG. 1C are exemplary schematic illustrations of a TRE sheath at different phases of the chemical consolidation process involving metal oxide to achieve a partially dehydrated TRE sheath.

FIG. 2A and FIG. 2B are exemplary schematic illustrations of the appearance and consistency of the TRE sheath without metal oxide (FIG. 2A) and the chemically consolidated TRE sheath with metal oxide (FIG. 2B).

### DETAILED DESCRIPTION

Conventionally, geothermal wells contain significant amounts of curable materials (e.g., cementitious materials) for strengthening of the grout mixture. However, in most instances curable materials do not exhibit desirably high thermal conductivity. As a result, some mixtures utilize a combination of curable materials and a thermally conductive material to improve thermal conductivity. But in such mixtures, the grout mixture has a continuous phase of the curable material where the curable material is typically greater by volume than the thermally conductive additive. While such compositions may have slightly improved thermal conductivity, these mixtures still lack high-thermal conductivity at best, or act as an insulator at worst, and have placement issues typically encountered with curable compositions (i.e., inadvertent, or premature curing to a strengthened state). Alternatively, particulate mixtures that are free of curable materials have also been utilized in certain subsurface applications, such as plugging underground pipes (see e.g., U.S. Pat. Nos. 6,715,543 and 7,258,174). While these particulate mixtures are free of curable materials, they lack desirable thermal conductivity, are typically not suitable for installation at the extreme temperatures (e.g., 300° C.) near a target location (e.g., geothermal energy source), and generally lack strength.

On the other hand, certain high-thermal conductivity fluid mixtures have also been disclosed. For example, in WO 2014/092940, methods and compositions are presented for introducing a shear-thinning, pumpable, and settable fluid into a well through a drill string or bottom hole assembly. While interesting, the '940 reference focuses on treating an oil or gas production well (i.e., changing a condition of a portion of a wellbore or a subterranean formation adjacent a wellbore) and reducing the amount of drilling fluid that is lost to the geological formation rather than improving thermal conductivity. In addition, such compositions and methods of consolidation can require long periods of time and are typically limited in thermal conductivity and mechanical strength capabilities.

On the other hand, WO 2023/150450 describes a slurry mixture comprising a high-thermal k material in the form of a plurality of particles with a wide size distribution that enable compaction of the particles under geostatic pressure in a fracture at a target location to form a TRE structure with high thermal conductivity that can even remain moveable in the presence of substantial forces (e.g., earthquakes). Although mechanistically intriguing, the compaction contemplated relies on the presence of geostatic pressure, which may significantly delay or even limit tight settling of the particles within the slurry in instances where geostatic pressure is reduced or lacking.

Thus, even though various composition and methods for geothermal heat transfer compositions are known in the art, all or almost all of them suffer from several drawbacks. Therefore, there remains a need for high-thermal conductivity compositions and systems that are pumpable, can thermally couple the geological formation to a casing within a wellbore at a high thermal conductivity, and exhibit high compressive strength.

The inventors have now discovered various compositions and methods of placing an enhanced thermal reach enhancement (TRE) sheath that is formed from a pumpable suspension comprising a mixture of suspended TRE particles in a high apparent viscosity carrier and a heat-activated consolidating additive (e.g., water scavenging additive, gelling additive, and/or strengthening additive). Advantageously, such mixtures can be delivered to a high temperature target region at which the viscosity of the suspension sufficiently decreases (or is chemically broken) to so deposit the TRE particles and the consolidating additive at the target region and at which the consolidating additive is activated to facilitate chemical consolidation of the TRE particles. Such compositions and methods are particularly beneficial as the time required for settling of the TRE particles is significantly reduced and as hydraulic consolidation (e.g., via fluid removal structures in or proximal to the TRE sheath as for example described in WO 2025/171172) can be entirely avoided.

As a result of the chemical consolidation of the TRE particles within an annular space between the wall of the wellbore and the casing of a heat exchanger, the resulting TRE sheath thermally couples a working fluid housed in a heat harvester casing to a geological resource in an efficient manner for improved thermal and/or electrical energy generation. Depending on the specific consolidating additive, a so formed chemically consolidated (e.g., partially dehydrated, viscoplastic, and/or strengthened) TRE sheath can have a thermal conductivity of at least 1 W/mK and a compressive strength of at least 0.5 psi. As will be described in more detail below, it should be noted that the suspension/slurry may be free of cementitious materials or may contain moderate quantities of curable cementitious materials (typically in quantities significantly less than the quantity of TRE particles). Among other benefits, the compositions contemplated herein will allow for simple preparation and placement using conventional equipment, allow for rapid formation of a consolidated sheath with desirable thermal conductivity at the target location, and generate a sheath with desirable stability and low porosity.

To achieve such benefits, it is generally contemplated that the heat-activated consolidating additive is an agent that is activated at an elevated temperature (e.g., at least 50° C., or at least 75° C., or at least 100° C., or at least 150° C., or at least 200° C., or at least 250° C., or even higher), resulting in a chemical reaction or structural change that consumes and/or displaces water in the pore space of settled TRE particles. For example, the heat-activated consolidating additive may be a metal oxide that reacts with water to form the corresponding metal hydroxide at elevated temperatures. In such case, it should be noted that in addition to water consumption most metal hydroxides will also expand and so further compress the TRE mass, thereby enhancing contact and thermal transfer between the TRE particles. In another example, the heat-activated consolidating additive may comprise a gelling agent that swells at elevated temperatures and as such reduces pore space in the TRE mass, or the heat-activated consolidating additive may comprise a temperature-sensitive gelling agent that expels water at high temperatures and as such once more compacts the TRE mass. In still other examples, the heat-activated consolidating additive may comprise a strengthening agent that may cure, and typically expand, in the presence of water at a higher temperature to so consume water and reduce pore space while providing increased mechanical strength.

As already noted above and discussed in more detail below, it should be recognized that these additives are delivered to the target location in a high-apparent viscosity carrier fluid that is pumpable, and that these additives then rapidly settle out from the high-apparent viscosity carrier fluid upon breaking the viscosity, which may be effected by temperature at the target location or by a chemical reaction that is initiated or accelerated after placement of the carrier fluid. In some embodiments, the viscosity agent and the heat-activated consolidating additive are selected such that the viscosity agent has a break-down temperature (i.e. temperature at which viscosity decreases due to temperature-induced degradation or other chemical change) that is lower that the reaction temperature of the heat-activated consolidating additive (i.e. temperature at which the heat-activated consolidating additive reacts to consume or displace water). As a consequence, it should be appreciated that the TRE particles in such slurries will be able to settle into a settled bed before the heat-activated consolidating additive will react with the water.

In view of the above, it should therefore be appreciated that the compositions and systems presented herein can provide significant advancements in the field of thermal energy transfer in geothermic plants. The energy produced by the geothermal systems contemplated herein may be used for heating or cooling (direct use applications) or may convert harvested heat to electricity through use of a surface power plant for thermal-to-electric energy conversion. Moreover, geothermal systems may be integrated with equipment that consumes energy, such as a geothermal plant for hydrogen or other renewable fuel production, carbon capture, or desalination. The geothermal well may circulate working fluid and thereby continuously produce energy at a constant rate, or the flow rate of the working fluid may be controlled such that the well produces a time-variable amount of energy.

Most significantly, the compositions and systems presented herein relate to a substantially improved pumpable suspension for formation of a consolidated (e.g., partially dehydrated, viscoplastic, and/or strengthened) thermal reach enhancement (TRE) sheath in the annular space between the walls of a geothermal wellbore and a casing of a heat harvesting element, where the consolidated TRE sheath has a thermal conductivity of at least 1 W/mK and a compressive strength of at least 0.5 psi. Preferably, but not necessarily, the consolidated TRE sheath may have a thermal conductivity of at least 1 W/mK, or at least 3 W/mK, or at least 5 W/mK, or at least 10 W/mK, or at least 25 W/mK, or at least 50 W/mK, or at least 100 W/mK, or at least 200 W/mK, or at least 300 W/mK, or at least 400 W/mK. For example, consolidated TRE sheaths may have a thermal conductivity between 1 W/mK and 3 W/mK, or between 2 W/mK and 5 W/mK, or between 4 W/mK and 10 W/mK, or between 10 W/mK and 20 W/mK, or between 15 W/mK and 50 W/mK, or between 50 W/mK and 150 W/mK, and even higher. Likewise, the TRE sheath may also have a compressive strength of at least 0.5 psi, or at least 1.0 psi, at least 2.5 psi, or at least 5.0 psi, or at least 10.0 psi, or at least 50 psi, or at least 100 psi, or at least 300 psi, or at least 400 psi, or at least 500 psi, or at least 700 psi, or at least 1,000 psi.

It should be appreciated that chemical consolidation can be performed in a variety of manners in which water in some form reacts with a chemical consolidation agent in situ to provide the various advantageous results such as improved thermal conductivity and/or compressive strength of a resulting consolidated TRE sheath. For example, chemical consolidation could be done by decreasing porosity of the mixture and forming a partially dehydrated TRE sheath when a water scavenging additive is used. Alternatively, chemical consolidation may increase the yield point of a viscoplastic TRE sheath when a gelling additive is used. In some embodiments, chemical consolidation may also increase compressive strength of the mixture and thereby form a strengthened TRE sheath when the strengthening additive is used.

Regardless of the specific chemical consolidation process used, the temperature at which the additive reacts with water in situ will typically be above 50° C., above 70° C., above 90° C., above 110° C., above 130° C., above 150° C., above 170° C., above 190° C., above 210° C., above 230° C., and even higher. Therefore, contemplated temperatures also include those between 50° C. and 90° C., between 75° C. and 120° C., between 100° C. and 150° C., between 150° C. and 200° C., between 200° C. and 300° C., and between 300° C. and 350° C. As mentioned earlier, these temperatures will in some embodiments be higher than the break-down temperature of the viscosity agent. For example, the reaction temperature of the heat-activated consolidating additive may be at least 10° C. higher, or at least 15° C. higher, or at least 20° C. higher, or at least 35° C. higher, or at least 50° C. higher, or at least 75° C. higher than the break-down temperature of the viscosity agent. Therefore, temperature differences may be between 1° and 30° C., or between 2° and 50° C., or between 5° and 100° C., or even higher. In this context it should be noted that contemplated additives will substantially not react (i.e., will form the reaction product in an amount of equal or less than 10%, and more typically equal or less than 7%, and most typically equal or less than 5% of the maximal yield at temperatures specified above) within 24 hours at the specified temperatures above, while contemplated additives will substantially react (i.e., will form the reaction product in an amount of at least 50%, and more typically at least 70%, and most typically at least 90% of the maximal yield at temperatures specified above) within 24 hours and at the specified temperatures above. Therefore, in some embodiments, the additive may react with water in situ at the target location to a substantial completion of at least 30%, at least 40%, at least 50%, at least 60%, at least 70%, at least 80%, or at least 90% within a time period of at least 6 hours, at least 12 hours, at least 24 hours, at least 48 hours, at least 72 hours, at least 5 days, at least 10 days, or at least 14 days upon entering the specified temperatures above. Of course, it should be recognized that the extent of the reaction completion as well as the time it takes for the reaction to reach completion may vary depending on the specific material and the temperature at which the reaction takes place.

Viewed from another perspective, when using a strengthening additive, chemical consolidation may occur when a reaction creates a bond between the TRE particles and/or the strengthening additive. When using a water scavenging additive, chemical consolidation may occur when there is a reduction in pore volume or porosity of the mixture. Whereas when using a gelling additive, chemical consolidation may occur when there is a change in composition behavior to increase the yield point of the consolidated TRE sheath (as compared a corresponding TRE mass without gelling additive). In some embodiments, any combination of additives may be used. For example, a chemically consolidated TRE sheath may be formed from the addition of both a water scavenging additive and a gelling additive to the mixture. In alternative examples, a chemically consolidated TRE sheath may be formed from the addition of a strengthening additive and a water scavenging additive. In yet another example, a chemically consolidated TRE sheath may be formed form the addition of a gelling additive and a strengthening additive. As will be readily appreciated, a chemically consolidated TRE sheath may also be formed by the additive of a water scavenging additive, a gelling additive, and a strengthening additive.

In one typical embodiment, a pumpable slurry comprises a metal oxide such as MgO as the heat-activated consolidating additive, an aqueous solution of carboxymethyl cellulose as the high apparent viscosity carrier fluid, and graphite particles as TRE particles. In this context, it should be appreciated that at ambient conditions such compositions will remain pumpable and placeable using typical operational equipment (e.g., blenders, mixers, pump trucks, etc.). However, as the composition heats during placement into the target zone, the high apparent viscosity carrier fluid thins, thereby depositing the TRE solids into a bed. Further heating of the so deposited TRE mass converts the MgO to the corresponding Mg(OH)₂, consuming water and significantly expanding in the process, thereby solidifying the bed of solids for improved thermal contact/transfer and geomechanical properties.

As will be readily appreciated, there are numerous other metal oxides besides magnesium oxide suitable for use herein due to the common chemical reaction of alkali metal oxides with water to produce metal hydroxides as in Reaction 1 below

[metal]O+H₂O→[metal][OH]2 Scheme 1

An advantage of using this chemical reaction in a geothermal application is that the reaction occurs quicker and more efficiently at elevated temperatures. With regard to the choice of metal oxides, it should be noted that the geostatic temperature at the target zone will at least in part determine the choice of metal oxide since some metal hydroxides will at an elevated temperature decompose back to the corresponding metal oxide and water. Given the above example, the inventors therefore contemplate that the placement of a TRE sheath around a casing of a heat harvesting element can be achieved in three phases: Provision or preparation of the slurry, placement of the particles from the slurry at the target zone and curing the particles to form the consolidated TRE sheath. In the slurry phase the particles are suspend in the viscous slurry, and the physical separation of the particles is dominated by the concentration (volume percent) of the particles in the slurry.

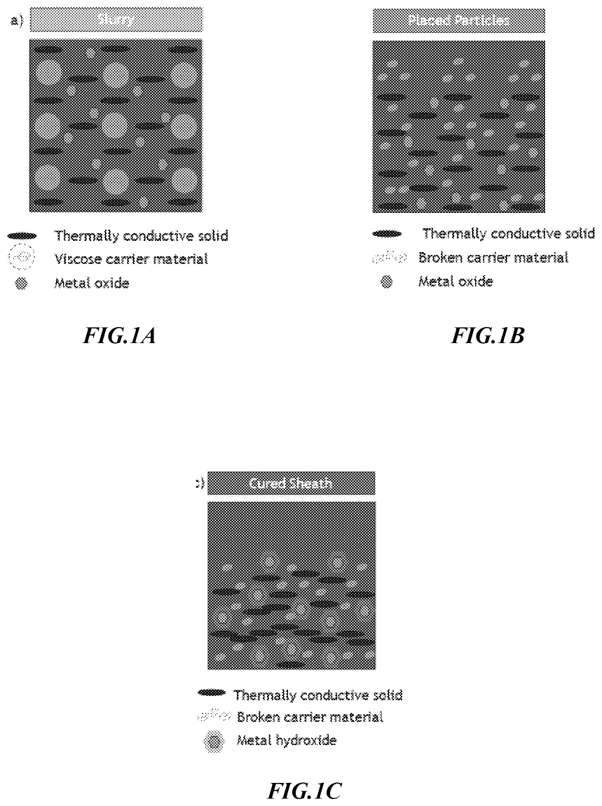

For example, as shown in FIG. 1A, the slurry comprises the TRE solids at about 30 volume percent of the slurry, suspended uniformly throughout the slurry. During the particle placement phase, as shown in FIG. 1B, the slurry has been pumped into the annulus at the target location and heat at the target location begins to break the viscous carrier material. As a consequence, the TRE solids are no longer uniformly suspended throughout the mixture and settle into a TRE mass. In column tests, thusly deposited particles typically have an average of 40 volume percent in the space occupied. During the final phase, the metal oxide particles react with surrounding free water (mostly water in the pore space) to form the corresponding metal hydroxide particles and so produce the consolidated sheath as depicted in FIG. 1C. In this context, it should be especially appreciated that metal hydroxides expand to approximately double the volume of the corresponding metal oxide. This ‘curing’ reaction (chemical consolidation) consumes free water, compresses the thermally conductive materials closer together, and so increases the thermal contact/transfer area between the grains. Therefore, it should be appreciated that addition of metal oxides to form metal hydroxides improves the packing efficiency of the thermally conductive solids (TRE particles), reduces the fluidity of the TRE particles, and imparts improved mechanical properties to the chemically consolidated sheath. These advantageous changes will improve the sheath performance with higher thermal conductivity, reduced fluid loss, and improved stability over time.

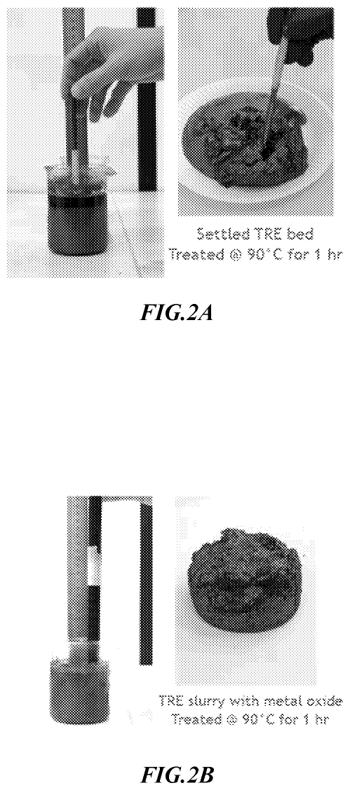

FIG. 2A depicts an exemplary TRE slurry placed without metal oxide where the slurry remains fluid, even after 1 hour at 90° C. In contrast, FIG. 2B depicts the same slurry with metal oxide as the heat-activated consolidating additive. As can be seen, the ‘cured’ material has less free water in the container, and a heavier rod placed onto the surface of the chemically consolidated TRE mass cannot penetrate the material. Indeed, when the TRE was removed from the container, it retained the shape and size formed during chemical consolidation. In this example, the MgO to Mg(OH)₂ reaction consumed water where 40 g of MgO (11.1 cm³) did immobilize 18 g (18 cm³) water and, once hydrated, magnesium hydroxide remained stable up to 380° C. in thermogravimetric measurements.

Of course, it should be appreciated that numerous TRE particles other than graphite are also deemed suitable for use herein, and it is generally contemplated that appropriate TRE particles include particles such as sand, diamond, silver, gold, rhodium, palladium, titanium, carbon fiber, carbon black, Hastelloy, quartz silica, carbon nanotubes, graphene, boron nitride, brass, brass alloy(s), chrome nickel steel, carbon steel, stainless steel, one or more transition metals (e.g., copper, cadmium, cobalt, gold, silver, iridium, iron, molybdenum, nickel, platinum, zinc, etc.), one or more transition metal alloys (e.g., copper alloy, cadmium alloy, cobalt alloy, gold alloy, silver alloy, iridium alloy, iron alloy, molybdenum alloy, nickel alloy, platinum alloy, zinc alloy, aluminum alloy, etc.), a post-transition metal (e.g., lead, tin, etc.), a post-transition metal alloy (e.g., lead alloy, tin alloy, etc.), an alkaline earth metal alloy (e.g., beryllium alloy, magnesium alloy, etc.), oxides and nitrides of transition metals and post-transition metals, ceramic composites containing silicon and/or aluminum, or combinations thereof. In certain embodiments, the TRE material is selected from the group consisting of graphite powder, exfoliated graphite, flaked graphite, pyrolytic graphite, desulfurized petroleum coke, graphene, fly ash, copper powder, aluminum nitride, alumina, silica, silicon carbide, and combinations thereof. Therefore, suitable TRE particles may also include carbon-based particles, inorganic particles made from or comprising a metal, a metal oxide, a metal nitride, an alloy, and/or hybrid materials, and in some embodiments, the TRE particles comprise at least two chemically distinct materials from the group listed above.

Viewed from a different perspective, the thermal conductivity of the bulk material from which contemplated TRE particles are formed will preferably have a thermal conductivity of at least 1.5 W/mK, at least 5 W/mK, at least 10 W/mK, at least 30 W/mK, at least 50 W/mK, at least 100 W/mK, at least 250 W/mK, at least 300 W/mK, or at least 400 W/mK. Thus, the thermal conductivity of the bulk material from which contemplated TRE particles are formed may be in the range of between 1.5 W/mK and 5.0 W/mK, or between 5.0 W/mK and 10 W/mK, or between 10 W/mK and 30 W/mK, or between 30 W/mK and 100 W/mK, or between 100 W/mK and 500 W/mK, and even higher. Moreover, it is generally preferred that the thermally conductive materials will have a particle size (or particle size distribution) and concentration to enable formation of a pumpable suspension in the carrier fluid.

Most typically, the TRE particles will have a shape that may include, but is not limited to, a platelet, a flake, a sphere, an irregular shape, a cube, a rod, a disc, a prism, a needle, a tube, a fiber, an angular shape, a subangular shape, a rounded shape, a subrounded shape, a dumbbell shape, and a star shape. Where desired, a first portion and a second portion of the plurality of particles may have a shape selected from the group listed above and where the shape of the first and second portions may be distinct. In some embodiments, a first portion of the plurality of TRE particles may have a composition and shape such that a mass of the first particles, upon dehydration, gelation, or strengthening, deforms elastically and plastically, and that a second portion of the particles may have a composition and shape such that a mass of the second particles, upon the compressional loading, deforms only elastically.

In various embodiments, the quantity of TRE particles used to achieve a desired thermal conductivity and/or compressive strength within the resulting chemically consolidated sheath may vary depending on the type and/or size of the individual particles so long as the particles enable formation of a pumpable suspension in the carrier fluid. For example, the TRE particles may have an average D50 particle size of between 0.05 μm and 5.0 mm, such as for example, between 0.05 μm and 5 μm, or between 5 μm and 50 μm, or between 50 μm and 500 μm, or between 500 μm and 5.0 mm. Additionally, contemplated TRE particles need not be of uniform size but may have a wide size distribution (e.g., spanning three or four orders of magnitude) or a narrow size distribution (e.g., within one order of magnitude). Therefore, contemplated TRE particles can have a particle size distribution that spans at least 2.0 log units, or at least 2.5 log units, and even wider.

Similarly, it should be appreciated that numerous heat-activated consolidating additives other than magnesium oxide are also expressly contemplated. For example, and as noted earlier, a water scavenging additive may be added to the mixture of water and TRE particles in order create a resulting partially dehydrated TRE sheath. Alternatively, a gelling additive may be added to the mixture of water and TRE particles to create a resulting viscoplastic TRE sheath. Lastly, a strengthening additive may be added to the mixture of water and TRE particles to create a strengthened TRE sheath. As will be readily apparent, these additives may be solid additives or liquid additives.

For example, and with respect to suitable water scavenging additives, it is generally contemplated that the water scavenging additive will account for between 0.1 and 50 wt % of a total weight of the mixture. Viewed from another perspective, the weight ratio of the TRE particles to the water scavenging additive is contemplated to be between 10:1 and 1:1. Therefore, in some embodiments, the water scavenging additive may account for between 1 and 15 wt %, or between 5 and 20 wt %, or between 15 and 30 wt %, or between 20 and 35 wt %, or between 30 and 45 wt %, or between 40 and 50 wt % of the slurry, while water may account for between 0.5 and 70 wt % of the total weight of the mixture prior to the water scavenging additive reacting with the water in situ. Such relatively high ratio of TRE particles to water scavenging particles advantageously favors thermal conductivity while allowing for chemical consolidation.

In various embodiments, prior to the water scavenging additive reacting with water in situ, the water may account for between 1 and 20 wt %, or between 10 and 30 wt %, or between 20 and 40 wt %, or between 40 and 60 wt %, or between 50 and 70 wt %, or between 70 and 90 wt % of the total weight of the slurry. However, after the water scavenging additive reacts with the water in situ, the water is contemplated to account for between 0.1 and 60 wt % of a total weight of the resulting partially dehydrated TRE sheath. In certain embodiments, after the water scavenging additive reacts with water in situ, the water may account for between 5 and 15 wt %, or between 15 and 30 wt %, or between 30 and 45 wt %, or between 45 and 60 wt % of a total weight of the resulting partially dehydrated TRE sheath. Regardless of the specific wt % of water before and after reacting with the water scavenging additive, it is generally contemplated that a reaction between the water scavenging additive and water results in a dehydrating-effect on the mixture.

Viewed from a different perspective, the resulting partially dehydrated TRE sheath after chemical consolidation is contemplated to have a lower water content as compared to the water content of the settled mixture prior to chemical consolidation. Therefore, the partially dehydrated TRE sheath may have a final porosity of equal or less than 70%, 60%, 50%, 40%, 30%, or 20% (such as, for example, between 15-25%, or between 20-35%, or between 30-40%) and/or may have a permeability of equal or less than 1 centiDarcy. In some embodiments, permeability may also be equal or less than 100 milliDarcy, or equal or less than 10 milliDarcy, or equal or less than 1 microDarcy.

Most typically, contemplated heat-activated water scavenging additives will be substantially inert at ambient temperatures (e.g., between 20-25° C.) but will react with water at an elevated temperature such as, for example, at a temperature of at least 50° C., or at least 75° C., or at least 100° C., or at least 150° C., or at least 200° C., or at least 250° C., or even higher, resulting in a chemical reaction and/or structural change that consumes and/or displaces water in the pore space of settled TRE particles.

Preferably, but not necessarily, the water scavenging additive is an oxide or hydroxide particle selected from the group comprising magnesium oxide, titanium oxide, manganese oxide, iron oxide, copper oxide, aluminum oxide, periclase, lime, manganosite, bunsenite, zincite, bromellite, tenorite, brucite, portlandite, pyrochroite, theophrastite, sweetite, behoite, and spertiniite. The water scavenging additive may also be selected from a group containing an organic material, a polymeric material, a dendritic polymer, a zeolite, a natural material, or a carbon-based material. Therefore, in some embodiments, the water scavenging additive is an inorganic material, a metal, a composite alloy, a mineral, or a ceramic. Therefore, the water scavenging additive may be in a liquid or solid form. Alternative water scavenging additives may be utilized so long as addition of the additive reduces the fluidity of the TRE suspension and improves the packing efficiency of the TRE particles by at least 5%. However, in various embodiments, packing efficiency may be improved by at least 10%, at least 20%, at least 40%, at least 50%, at least 70%, or more (such as, for example, between 5-15%, or between 10-25%, or between 20-35%, or between 30-50%, or even higher). In this context, it should be noted that the term ‘packing efficiency’ refers to the percentage of the total space, which is occupied by particles within a given space, i.e., how tightly particles are packed together. Therefore, packing efficiency is equal to 1-porosity. For example, if the chemically consolidated TRE sheath has a porosity of 0.4 (or 40%), then its packing efficiency is 1-0.4=0.6 (or 60%). This means that 60% of the total volume is occupied by the TRE particles, and 40% is void space (or water in the context of the partially dehydrated TRE sheath). The packing efficiency of a resulting chemically consolidated TRE sheath may be at least 30%, at least 50%, at least 70%, or at least 90%. For example, prior to chemical consolidation, the packing efficiency of the mixture may be 20%, whereas after chemical consolidation the packing efficiency may be improved by 10% to result in a TRE sheath with a packing efficiency of 30%.

Regardless of the specific water scavenging additive used, it is generally contemplated that the water scavenging additive reduces the overall pore volume of the chemically consolidated TRE material. As a result, it is also contemplated that the water scavenging additive may impart improved mechanical properties such that the resulting partially dehydrated TRE sheath has an increased stiffness (that may allow for a compressive strength of greater than 0.5 psi as discussed above). Moreover, the improved mechanical properties may also include the partially dehydrated TRE sheath's ability to withstand various forces beyond improved compressive strength. For example, the resulting partially dehydrated TRE sheath may have improved tensile, shear, impact, or flexural strength.

In further embodiments, the heat-activated consolidating additive may be a temperature responsive gelling additive, and it is generally contemplated that the gelling additive may exhibit temperature-dependent swelling/water absorption, phase change, or syneresis. Thus, suitable gelling additives will include inorganic or organic polymeric gelling agents such as bentonite, sepiolite, attapulgite, laponite, natural gelling polymers, modified natural polymers, synthetic polymers, and biopolymers. Regardless of the specific gelling additive used, it is generally contemplated that the weight ratio of the TRE particles to the gelling additive is between 10:1 and 1:1, which will advantageously favor formulations with high thermal conductivity. Moreover, where gelling agents exhibit swelling (e.g., bentonite swells/expands up to 15-20 time that of dry volume at temperatures up to 150° C.), gelling agents will also compress the mass of settled TRE particles, thereby enhancing contact of and thermal transfer among TRE particles. On the other hand, where the gelling agent exhibits syneresis at elevated temperatures, pore volume will significantly decrease and once more enhance contact of and thermal transfer among TRE particles.

Suitable gelling agents include those that are activated (i.e., swell or expel water) at an elevated temperature (e.g., at least 50° C., or at least 75° C., or at least 100° C., or at least 150° C., or at least 200° C., or at least 250° C., or even higher), resulting in a structural change that consumes and/or displaces water in the pore space of settled TRE particles to so increase contact of and thermal transfer among the TRE particles.

Preferably, but not necessarily, the gelling additive may account for between 0.1 and 50 wt % of a total weight of the mixture. However, in some embodiments, the gelling additive may account for between 10 and 20 wt %, or between 20 and 30 wt %, or between 30 and 40 wt %, or between 40 and 50 wt %, or between 50 and 60 wt % of a total weight of the mixture. Most typically, the water in contemplated slurries accounts for between 0.5 and 70 wt % of a total weight of the slurry prior to the gelling additive reacting with the water in situ. Viewed from another perspective, the water may account for between 0.5 and 5 wt %, or between 1 and 10 wt %, or between 5 and 15 wt %, or between 10 and 20 wt %, or between 15 and 25 wt %, or between 20 and 30 wt %, or between 25 and 35 wt %, or between 30 and 40 wt % before the gelling additive reacting with the water in situ. Similar to the discussion for the partially dehydrated TRE sheath, the wt % of gelling additive and water of the viscoplastic TRE sheath may vary, however, one guiding feature is the ability of the gelling additive to react with water in situ to increase the yield point of a viscoplastic TRE sheath. Moreover, and depending on the particular gelling agent used, it should be recognized that the gelling agent may be in liquid form or solid form.

In still further embodiments, the heat-activated consolidating additive may be a temperature sensitive strengthening additive, and in most cases, the strengthening additive is an inorganic cement or organic resin that will cure at elevated temperatures. However, contrary to conventional thermally conductive cement formulations, the compositions contemplated herein will have TRE particles as the predominant fraction to facilitate improved thermal conductivity. Therefore, the weight ratio of the TRE particles to the strengthening additive may be between 10:1 and 1:1. Accordingly, the volume of the strengthening additive will preferably also be less than the volume of the TRE particles. For example, the strengthening additive may be present in the pumpable suspension in an amount of at least 1 vol %, at least 10 vol %, at least 20 vol %, at least 30 vol %, or at least 40 vol % based on total volume of the pumpable suspension, but less than 50 vol %. Whereas the TRE particles may be present in the pumpable suspension in an amount of at least 60 vol %, at least 70 vol %, at least 75 vol %, at least 80 vol %, at least 85 vol %, at least 90 vol % or even higher based on total volume of the pumpable suspension. Viewed from a different perspective, it is contemplated that the strengthening additive may account for between 1 and 25 wt %, between 25 and 50 wt %, or between 50 and 75 wt % of a total weight of the mixture.

Whereas the water may account for between 0.5 and 40 wt % of a total weight of the slurry prior to the strengthening additive reacting with the water in situ. In various embodiments, the water may account for between 1 and 20 wt %, or between 10 and 30 wt %, or between 15 and 25 wt %, or between 20 and 40 wt %, or between 35 and 50 wt %, or between 40 and 60 wt % of the slurry prior to the strengthening additive reacting with the water in situ. However, after the strengthening additive reacts with the water in situ, the water may account for between 0.1 and 60 wt % of a total weight of the resulting strengthened TRE sheath. In some embodiments, the water may account for between 1 and 15 wt %, or between 10 and 20 wt %, or between 15 and 30 wt %, or between 30 and 40 wt %, of a total weight of the resulting strengthened TRE sheath. However, in some embodiments, the difference in water content between the resulting strengthened TRE sheath and the mixture prior to chemical consolidation may be minimal. Overall, after chemical consolidation, the resulting strengthened TRE sheath is contemplated to have a lower water content and/or lower porosity as compared to the water content or porosity of the mixture prior to chemical consolidation. Regardless of water content and porosity, the strengthen TRE sheath will typically have an increased compressive strength, typically by at least 0.5 psi, or at least 5 psi, or at least 10 psi, or at least 15 psi, or at least 25 psi, or at least 50 psi.

Suitable strengthening additives include those that are activated (i.e., cure/harden in the presence of water) at an elevated temperature of at least 50° C., or at least 75° C., or at least 100° C., or at least 150° C., or at least 200° C., or at least 250° C., or even higher, resulting in a structural change that consumes water in the pore space of settled TRE particles to that increase mechanical strength of the consolidated TRE sheath.

In general, the specific wt % of the strengthening additive and water is guided by the desired properties of the resulting TRE sheath to be achieved. In some embodiments, the compressive strength may be at least 0.5 psi, at least 1.0 psi, at least 50 psi, at least 100 psi, at least 200 psi, at least 300 psi, at least 400 psi, at least 500 psi, or at least 600 psi. Nonetheless, specific weight percentages of water and the strengthening additive may be adjusted to achieve the desired thermal conductivity and compressive strength of the resulting strengthened TRE sheath. The resulting strengthened TRE sheath may also be defined by improvement in compressive strength of the TRE particles. For example, the strengthening additive may improve the compressive strength of the TRE particles by at least 0.5 psi, or at least 5 psi, or at least 10 psi, or at least 15 psi, or at least 25 psi, or at least 50 psi.

Alternatively, or additionally, the strengthened TRE sheath may have a final porosity of equal or less than 70%, 60%, 50%, 40%, 30%, or 20% and/or may have a permeability of equal or less than 1 centiDarcy. However, in some embodiments the water volume and/or porosity of the strengthened TRE sheath may be the same as or similar to the water volume and/or porosity of the TRE suspension prior to chemical consolidation. Likewise, permeability of the strengthened TRE sheath may also be the same as or similar to the permeability of the TRE suspension prior to chemical consolidation. Nonetheless in various embodiments, permeability of the strengthened TRE sheath may be equal or less than 10 milliDarcy, or equal or less than 1 milliDarcy, or equal or less than 100 microDarcy, or equal or less than 10 microDarcy. Overall, the strengthening additive is contemplated to reduce the fluidity of the TRE suspension.

With respect to high-apparent viscosity carrier fluids, it is generally contemplated that the carrier fluid has a viscosity that is suitable for mixing with and suspending the heat-activated consolidating additive(s) and TRE particles at the desired concentrations at low temperatures (e.g., below 35° C., or below 30° C., or below 25° C.), and that yields a pumpable slurry after mixing with the heat-activated consolidating additive(s) and TRE particles. For example, suitable high-apparent viscosity carrier fluids before mixing with the heat-activated consolidating additive(s) and TRE particles will have an apparent dynamic viscosity of between about 300 cP to 10 cP measured at 170 s⁻¹ at room temperatures. Moreover, it is contemplated that the high-apparent viscosity carrier fluid will significantly change viscosity at an elevated temperature (from higher to lower viscosity) such that the heat-activated consolidating additive(s) and TRE particles will no longer be suspended but will settle at the target location. Alternatively, or additionally, it is contemplated that the high-apparent viscosity carrier fluid may also have a composition that allows viscosity breaking with a chemical, enzymatic, or other environmental factor such that the heat-activated consolidating additive(s) and TRE particles will no longer be suspended but will settle at the target location.

For example, suitable high apparent viscosity carrier fluids include various polymer-based fluids in which the polymer chains break down (e.g., via hydrolysis and/or oxidation) when exposed to high temperatures such as above 90° C., or 110° C., or 150° C., or 170° C. or 200° C.), leading to a drastic reduction in viscosity. In some embodiments, the break-down temperature of the viscosity agent that generates the high apparent viscosity in the carrier fluid will be less than the reaction temperature of the heat-activated consolidating additive. For example, the break-down temperature may be between 5-15° C., or between 10-30° C., or between 25-50° C., or between 50-100° C., or between 100-150° C. below the reaction temperature. Among other options, such polymers include regular polyanionic cellulose (PAC-R), carboxymethyl cellulose, pre-gelatinized starch, xanthan gums, etc. Moreover, while temperature increase is the preferred mechanism of viscosity decrease, other mechanisms are also deemed appropriate and include enzymatic breakdown of polymeric materials, acid or base catalyzed hydrolysis, change in pH, etc. Therefore, one or more triggering events to reduce viscosity include a change in pH, a change (increase) in temperature, or presence of a degrading agent are generally contemplated.

Therefore, contemplated high apparent viscosity carrier fluids may have a composition that allows reducing the viscosity with an additive such as an oxidizer, a biobased enzyme, bacteria, and/or a pH modifier, and/or that allows reducing the viscosity with a shear force or temperature change. Consequently, the high apparent viscosity carrier fluid may comprise a viscosity agent in an amount of between 0.001 and 10 wt % of the total suspension. Preferably, but not necessarily, the high apparent viscosity carrier fluid suspends the plurality of TRE particles until the viscosity of the carrier fluid is reduced at the target location by the triggering event in situ. Most typically, the plurality of TRE particles will have a size that allows settling of the TRE particles within 24 hours after reducing the viscosity. Consequently, the plurality of TRE particles will settle to form a mass that has a thermal conductivity of between about 1 W/mK and 2.5 W/mK, or between about 2 W/mK and 5 W/mK, or between about 5 W/mK and 10 W/mK, or between about 10 W/mK and 25 W/mK, between about 20 W/mK and 100 W/mK, which will be significantly increased after chemical consolidation.

Therefore, it is contemplated that the high apparent viscosity carrier fluid comprises a water-soluble biopolymer, a water-soluble derivatized biopolymer, a water-soluble gum, water-soluble cellulose, and/or a water-soluble synthetic polymer. As will be readily appreciated, the gum, cellulose, polymer, or biopolymer in the carrier fluid may form a network, may be crosslinked, or form a supramolecular structure. In some embodiments, the gum, cellulose, polymer, or biopolymer bonds to the TRE particles and forms a suspended particle, a particle filled network, a crosslinked particle filled polymer network, or form a particle filled supramolecular structure.

Therefore, and among other suitable choices, the viscosity agent may include a guar gum, a polysaccharide (starch, guar, cellulose, cellulose derivatives, alginates, carrageenan, or locust gum), a xanthan, hydroxylethyl cellulose (HEC), a carboxymethyl guar (CMG), carboxymethyl hydroxylethyl cellulose (CMHEC) a hyperbranched polyglycerol (HPG), a carboxymethyl hydroxypropyl guar (CMHPG), a carboxymethyl cellulose (CMC), a high strength molding compound (HMC), an acrylamide, and/or a poly(acrylamide/acrylic acid/2-acrylamido-2-methylpropane sulfonic acid) (AMPS-AA-AM), and optionally a viscoelastic surfactant (VES). Most typically, the viscosity agent is present in an amount of between 0.01 and 20 wt % of the pumpable suspension.

It is further contemplated that the pumpable suspension may optionally comprise a second additive that promotes the association of the plurality of TRE particles to a viscosity agent to thereby improve mixing and dispersion of the plurality of TRE particles within the high apparent viscosity carrier fluid. In some embodiments, the pumpable suspension may optionally comprise a second additive that absorbs thermal energy to extend the usable temperature range for a given polymer by between 5° C. and 50° C. Alternatively, or additionally, a de-airing additive may be present in the pumpable suspension in an amount sufficient to prevent, destroy, or release trapped air bubbles such that the steps of settling and consolidation are optimized. Such additives may include a variety of defoamers such as polydimethylsiloxanes, alcohols, stearates, glycol, surfactants, alkylphenol ethoxylate, silicone defoamers, mineral oil defoamers, vegetable oil defoamers, wax-based defoamers, and/or polymer defoamers. However, silicone-free defoamers may also be used.

Plasticizers may be present in the suspension to improve workability for ease of placement. In various embodiments, the term “plasticizer” refers to a material that increases the fluidity. Suitable plasticizers may include polycarboxylic ether plasticizers, phthalate plasticizers, terephthalate plasticizers, sulfonamide plasticizers, benzoate plasticizers, phosphate plasticizers, or combinations thereof. In some embodiments, the plasticizer may be present in the pumpable suspension in an amount sufficient to provide the desired amount of workability to the pumpable suspension. The plasticizer may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the plasticizer may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the plasticizer may be present in the pumpable suspension in an amount of from about 1 to about 20 wt. %, from about 5 wt. % to about 15 wt. %, or from about 7 wt. % to about 13 wt. %, based on a total weight of the pumpable suspension.

Moreover, it should be appreciated that one or more surfactants may be present in the pumpable suspension to improve surface properties of the pumpable suspension. Suitable surfactants may include, but are not limited to, a non-ionic surfactant, an anionic surfactant, a cationic surfactant, a zwitterionic surfactant, or combinations thereof.

For example, suitable non-ionic surfactants include an alkyoxylate (e.g., an alkoxylated nonylphenol condensate, such as poly(oxy-1,2-ethanediyl), alpha-(4-nonylphenyl)-omega-hydroxy-branched), an alkylphenol, an ethoxylated alkyl amine, an ethoxylated oleate, a tall oil, an ethoxylated fatty acid, an alkyl polyglycoside, a sorbitan ester, a methyl glucoside ester, an amine ethoxylate, a diamine ethoxylate, a polyglycerol ester, an alkyl ethoxylate, an alcohol that has been polypropoxylated and/or polyethoxylated, a linear alcohol alkoxylate, dodecylbenzene sulfonic acid salt derivative, a linear nonyl-phenol, dioxane, ethylene oxide, polyethylene glycol, an ethoxylated castor oil, polyoxyethylene nonyl phenyl ether, tetraethyleneglycoldodecylether, ethylene oxide, decylamine oxide, dodecylamine oxide, an alkylamine oxide, an ethoxylated amide, an alkoxylated fatty acid, an alkoxylated alcohol (e.g., lauryl alcohol ethoxylate, ethoxylated nonyl phenol), an ethoxylated fatty amine, an ethoxylated alkyl amine (e.g., cocoalkylamine ethoxylate), any derivative thereof, and any combination thereof.

Suitable anionic surfactants include a methyl ester sulfonate, a hydrolyzed keratin, polyoxyethylene sorbitan monopalmitate, polyoxyethylene sorbitan monostearate, polyoxyethylene sorbitan monooleate, an alkyl ether sulfate, sodium 4-(1′heptylnonyl)benzenesulfonate, sodium dioctyl sulphosuccinate, sodium octlylbenzenesulfonate, sodium hexadecyl sulfate, sodium laureth sulfate, a quaternary ammonium compound (e.g., a trimethylcocoammonium chloride, a trimethyltallowammonium chloride, a dimethyldicocoammonium chloride, and the like), a cetylpyridinium chloride, an alkyl ester sulfonate, an alkyl ether sulfonate, an alkyl ether sulfate, an alkali metal alkyl sulfate, an alkyl sulfonate, an alkylaryl sulfonate, a sulfosuccinate, an alkyl disulfonate, an alkylaryl disulfonate, an alkyl disulfate, an alcohol polypropoxylated sulfate, an alcohol polyethoxylated sulfateany derivative thereof, or any combination thereof.

Suitable zwitterionic surfactants may include, but are not limited to, an alkyl amine oxide, an alkyl betaine, an alkyl arnidopropyl betaine, an alkyl sulfobetaine, an alkyl sultaine, a dihydroxyl alkyl glycinate, an alkyl ampho acetate, a phospholipid, an alkyl aminopropionic acid, an alkyl imino monopropionic acid, an alkyl imino dipropionic acid, dipalmitoyl-phosphatidylcholine, an amine oxide, a betaine, a modified betaine, an alkylamidobetaine (e.g., cocoamidopropyl betaine), and any combination thereof.

Moreover, surfactants that may exhibit viscoelastic properties may include a sulfosuccinate, a taurate, an amine oxide (e.g., an amidoamine oxide), an ethoxylated amide, an alkoxylated fatty acid, an alkoxylated alcohol, an ethoxylated fatty amine, an ethoxylated alkyl amine, a betaine, modified betaine, an alkylamidobetaine, a quaternary ammonium compound, an alkyl sulfate, an alkyl ether sulfate, an alkyl sulfonate, an ethoxylated ester, an ethoxylated glycoside ester, an alcohol ether, any derivative thereof, and any combination thereof.

In some embodiments, the surfactant may be present in the pumpable suspension in an amount sufficient to provide the desired amount of surface properties to the pumpable suspension. The surfactant may be present in the pumpable suspension in an amount of at least 1 wt. %, 2 wt. %, 3 wt. %, 4 wt. %, 5 wt. %, 6 wt. %, 7 wt. %, 8 wt. %, 9 wt. %, or 10 wt. %, based on a total weight of the pumpable suspension. Alternatively, the surfactant may be present in the pumpable suspension in an amount of no greater than 20 wt. %, 19 wt. %, 18 wt. %, 17 wt. %, 16 wt. %, 15 wt. %, 14 wt. %, 13 wt. %, 12 wt. %, 11 wt. %, or 10 wt. %, based on a total weight of the pumpable suspension. Alternatively, the surfactant may be present in the pumpable suspension in an amount of from about 1 to about 20 wt. %, from about 5 wt. % to about 15 wt. %, or from about 7 wt. % to about 13 wt. %, based on a total weight of the pumpable suspension.

In view of the above, it will be readily appreciated, that the inventors contemplate a system for heat transfer from a geological formation to a heat harvester casing that comprises a heat harvester casing disposed in a wellbore that descends from a topside location to a target location in a geological formation. A chemically consolidated TRE sheath as discussed above is then formed in the annular space between the wall of the wellbore and the casing to so thermally couple the casing to the wall of the wellbore.

As discussed above, the chemically consolidated TRE sheath may have a thermal conductivity of at least 1 W/mK, at least 3 W/mK, or at least 5 W/mK, or at least 10 W/mK, or at least 25 W/mK, or at least 50 W/mK, or at least 100 W/mK, or at least 200 W/mK, or at least 300 W/mK, or at least 400 W/mK. For example, such TRE sheaths may have a thermal conductivity between 1 W/mK and 3 W/mK, or between 3 W/mK and 7 W/mK, or between 5 W/mK and 10 W/mK, or between 10 W/mK and 30 W/mK, or between 25 W/mK and 50 W/mK, or between 50 W/mK and 150 W/mK, and even higher. Most typically, the TRE particles in the chemically consolidated TRE sheath form a contiguous network of compacted material, as shown in FIG. 2, thermally coupling the casing with a wall of the wellbore.

Regardless of the kind of TRE sheath formed (e.g., partially dehydrated, viscoplastic, and/or strengthened), the inventors also contemplate a method of placing a TRE sheath around a closed-loop working fluid casing that is disposed in a wellbore at a target location within a geological formation. Most typically, the steps for placement include pumping the suspension containing the water scavenging, gelling, and/or strengthening additive into an annular space of the wellbore, wherein the annular space exists between the closed-loop working fluid casing and a wellbore wall at the target location, wherein the target location has a geostatic temperature sufficient for partial dehydration, gelation, or strengthening of the suspension, and waiting for a time sufficient for dehydration, gelation, or strengthening of the suspension around the closed-loop working fluid casing to thereby form the consolidated TRE sheath. In addition, and as noted above, the viscosity of the carrier fluid will be reduced (by temperature or chemically) at the target location to so allow settling of the TRE particles and heat-activated consolidating additive.

In further contemplated aspects, the consolidated TRE sheath may be formed in multiple consecutive segments, particularly where the TRE sheath has a significant length (as settling of particles exponentially increases with the distance of settling particles). Therefore, a chemically consolidated TRE sheath can be produced over successive rounds of placing the slurry, settling the particles, and chemical consolidation. Therefore, the steps of placing the suspension and/or the step of waiting for the chemical consolidation to conclude is sequentially performed until the TRE sheath covers at least 1%, or at least 5%, or at least 10% of a vertical height of the casing. In some embodiments, the step of waiting is performed until the TRE sheath covers at least 20%, or at least 40%, or at least 60%, or at least 80%, or at least 90% of the vertical height of the casing. Preferably, but not necessarily, the casing may have a vertical length of between 10 m and 20 m, or between 15 m and 30 m, or between 30 m and 50 m, or between 50 m and 100 m, or between 100 m and 500 m, or between 500 m and 1,000 m, or between 1,000 m and 5,000 m, or between 5,000 m and 10,000 m, or more In various embodiments, the TRE sheath covers between 10% and 100% of a perimeter of the casing. Alternatively, or additionally, one may wait for at least 24 hours, at least 48 hours, at least 36 hours, at least 72 hours, or at least 120 hours for formation of the TRE sheath.

Regardless of the height of the TRE sheath or the time it takes for TRE sheath formation, the target location typically has a target temperature of at least 120° C., at least 180° C., at least 250° C., at least 300° C., at least 350° C., at least 400° C., at least 450° C., or at least 500° C., or at least 600° C. and/or the target location may be below ground at a depth of at least 150 m, at least 300 m, at least 500 m, at least 600 m, at least 700 m, at least 800 m, at least 900 m, at least 1,000 m, at least 1,250 m, at least 1,500 m, at least 1,750 m, at least 2,000 m, at least 2,500 m, at least 3,000 m, at least 4,000 m, at least 5,000 m, at least 10,000 m, or at least 20,000 m.

In certain embodiments, the target location extends in a substantially vertical orientation. The term “substantially” as utilized herein means that the target location extends toward the center of the earth but may be offset from the center by no greater than 15 degrees, no greater than 10 degrees, no greater than 5 degrees, or no greater than 1 degree. It is to be appreciated that the geothermal wellbore may have multiple target locations and thus may have both substantially vertical orientated target locations and target locations extending in orientations that are at least 30 degrees.

The target location, typically being a hot dry rock (e.g., intrusive igneous or metamorphous rock, granitic, basaltic, sedimentary), may or may not include a plurality of fissures that longitudinally extend from the wellbore into the formation. In other embodiments, the target location may also comprise permeable or impermeable rock. Additionally, it is contemplated that the geothermal system may be located in hot wet rock, a “greenfield”, a “brownfield”, the ocean floor, and/or an oil/gas well. In terms of using oil/gas wells, geothermal energy may be harnessed through the retrofitting of inactive or unproductive wells and co-production on active wells. For example, an old well may be cleaned out then installed with contemplated systems herein. In a further example, an old well may be cleaned out, then deepened prior to installation of systems contemplated herein. Alternatively, an old well may be cleaned out, sidetracked, drilled, and then have the contemplated systems installed. In terms of drilling on the ocean floor, it is contemplated that a geothermal system could be placed at or near seafloor spreading rifts. Drilling on the ocean floor may also be anywhere else where geothermal energy can be extracted, such as major tectonic plate boundaries or rift zones.

Regardless of the target location, in various embodiments, the wellbore may include man-made and/or naturally occurring fissures, and such fissures may longitudinally extend from the wellbore over a distance of at least 3 m, at least 4 m, at least 5 m, at least 6 m, at least 7 m, at least 8 m, at least 9 m, or at least 10 m, and even more. The fissures can be at least partially filled with a high-thermal k material or thermal reach enhancement (TRE) particles to so form TRE structures. In some embodiments, at least 10%, at least 20%, at least 30%, at least 40%, at least 50%, at least 60%, at least 70%, at least 80%, or at least 90%, and even more, of the volume of each of the fissures contains the high-thermal k material.

The fissures are contemplated to be adjacent to the wellbore and at least partially filled with a high-thermal conductivity material to thereby form a plurality of thermal reach enhancement (TRE) structures. When TRE structures are implemented, the high-thermal conductivity material in the TRE structures is contemplated to be thermally coupled with the partially dehydrated, viscoplastic, or strengthened TRE sheath in the wellbore. Most typically, a first high thermal k material of the proximal mouth portion of the first and/or second TRE structure is flush to the annular space of the wellbore and/or the (partially dehydrated, viscoplastic, or strengthened) TRE sheath within the annular space of the wellbore to thereby allow continuous heat transfer from the geological formation, through the TRE sheath and heat harvester casing, to the wellbore and the working fluid.

In further contemplated aspects, TRE structures may have a width between 1 mm and 10 mm, between 5 mm and 30 mm, or between 10 and 50 mm, or between 25 and 80 mm, or between 1 mm and 100 mm. In some embodiments, the TRE structures may extend into the formation a longitudinal distance of at least 1 m, at least 50 m, at least 100 m, at least 150 m, or at least 200 m. Still further, and regardless of the specific configuration, it is contemplated that the fissures, and subsequent TRE structures placed within the fissures, in the target location may not only be a single linear break in the rock formation but may also form a complex structure (such as a reticular or dendritic structure). Advantageously, such complex structure will provide for an even larger thermal exchange surface with the remainder of the unfractured rock in the target location. For example, the TRE structures may be formed to have a longitudinal complex multi-fractured geometry with a width of between 10 mm and 50 mm and a length of at least 10 m as measured from the wellbore. However, despite a given width and length of a fissure, the effective length is the amount of the fissure that may be used for the TRE structure. For example, a fissure may be 200 m in total length but only 10 m is the effective length for the TRE structure. Nonetheless, regardless of the specific dimensions it is generally preferable that the TRE structure has a width that decreases from the proximal mouth portion to the distal portion, where the TRE structure extends longitudinally along the wellbore.

As previously mentioned, it should be noted that the compacted high-thermal k material of the TRE structure will typically terminate on a proximal end at the target location of the wellbore such that the high-thermal k material is in uninterrupted (continuous) thermal exchange with the TRE sheath in the wellbore. Thus, the high-thermal k material of the proximal mouth portion of the TRE structure is typically (but not necessarily) flush to the wellbore and/or any annular space within the wellbore. Consequently, a continuous heat transfer path is formed from the target location in the geological formation, via the TRE structure and TRE sheath, to the casing and subsequently to the working fluid within the casing. Furthermore, in at least some embodiments the TRE structure will have a wedge-shaped configuration. Therefore, it should be appreciated that the high-thermal k material of the fissures provides additional thermally conductive surfaces to improve heat extraction from target areas within the formation as opposed to only surfaces of the formation immediately adjacent to the wellbore. Viewed from a different perspective, the high-thermal k material in the fissures will act as a radiator fin or wing that acts as a heat exchange surface to provide significantly improved heat transfer on a per unit length basis of the wellbore, which in turn increases revenue generation for power producing wells. In some embodiments, the TRE structures are at least partially filled with the partially dehydrated, viscoplastic, or strengthened sheath. That being said, the TRE structure may also have a thermal conductivity of at least 1 W/mK, at least 3 W/mK, at least 5 W/mK, or at least 10 W/mK, or at least 25 W/mK, or at least 50 W/mK, or at least 100 W/mK, or at least 250 W/mK, or at least 500 W/mK.

### EXAMPLES

The invention having been generally described, the following examples are provided to illustrate exemplary embodiments of the inventive subject matter and to demonstrate the effect of a heat-activated water scavenging additive on chemical consolidation and thermal performance of the thermal reach enhancement (TRE) suspension. These examples are provided for illustrative purposes only and are not intended to limit the scope of the claims.

Exemplary formulations. Three pumpable TRE suspensions were prepared having identical base compositions and differing only in the presence and concentration of a heat-activated water scavenging additive as shown in Table 1. Each formulation comprised water, a viscosity modifier (polysaccharide-based polymer), and thermally conductive TRE particles (graphite). Magnesium oxide (MgO) was used as the water scavenging additive where indicated. For Example 2, it should be appreciated that numerous alternative TRE particles, viscosity modifiers, and heat-activated consolidating additive as compared to Examples 1, 3, and 4 can be used as described above, and the skilled artisan will be readily apprised of the suitable choice depending on the particular purpose.

TABLE 1

| | Example 1 | Example 2 | Example 3 | Example 4 |
|---|---|---|---|---|
| Component | (Control) | (General) | (Low MgO) | (High MgO) |
| Water | 74 vol % | 40-80 vol % | 71.4 vol % | 68.8 vol % |
| Viscosity | 0.4 g/100 mL | 0.1-2.0 g/100 mL | 0.4 g/100 mL | 0.4 g/100 mL |
| modifier | water | water | water | water |
| TRE particles | 26 vol % | 10-45 vol % | 26 vol % | 26 vol % |
| Water scavenging | None | Metal oxide | MgO, 2.6 vol % | MgO, 5.2 vol % |
| additive | | 0.5-20.0 vol % | | |

Slurry preparation. All materials were combined in an API cement mixer at 1250 RPM. Water was added first, then viscosity modifiers were allowed to hydrate for 10-minutes at constant speed. The dry TRE particles and water scavenging magnesium oxide were pre-blended then added to the viscosified water slowly until all solid material was incorporated and uniform. After all the dry blend was added to the blender and the slurry was mixed for an additional 5-minutes.

Ambient stability. All the example formulations were monitored for hardness or consistency changes when held at 20° C. for 24-hours. The penetrometer penetration depth didn't change for all three formulations. All formulations were pumpable and exhibited no measurable chemical consolidation or hardening prior to thermal activation.

Thermal activation and consolidation performance. The example formulations from Table 1 were cured at 190° C. for 24-hours. The pressurized cells were loaded with excess water and placed in the oven for curing.

Temperature effects. The viscosity modifier destabilizes at 130° C., quickly reducing the viscosity to water thin and allowing the solids to settle out. Typical settled beds of the thermal enhancers have a porosity of ~60% which would deposit the solids to an approximate total bed height of 43 vol %, 47.7 vol %, and 52.0 vol % of the chamber for the control, low MgO, and high MgO samples, respectively. Since the polymer breaking kinetics are much faster than the thermal activation of the MgO, the MgO and TRE particles will settle into a packed bed before the MgO begins to react with the excess water. Resulting in packed beds with approximately 0 vol %, 4.3 vol % and 8.6 vol %, for the control, low MgO, and high MgO samples, respectively.

At elevated temperatures magnesium oxide reacts with free water to form magnesium hydroxide (Mg(OH)₂) at a stochiometric ratio of 1:1. The density of MgO is 3.58 g/cm³ and Mg(OH)₂ is 2.34 g/cm³ which means the volume of MgO increases by a factor of 1.5 times the original volume. The resulting effects are reduced water between the thermal enhancer particles and expansion of the MgO to increase contacts between thermal enhancer particles.

Thermal conductivity. Samples cured at 190° C. were removed from the curing chamber in two parts, the upper supernatant and the lower packed bed. Each lower packed bed sample was loaded into a cell to determine the effective thermal conductivity change due to the water scavenging additive. The thermal conductivity improved 133% for the low MgO sample and 217% for the high MgO sample.

Cohesion. The control samples after 24-hours at ambient and 190° C. both had a penetrometer depth of 35±1.3 mm, showing no sign of resisting the penetration of the probe. The high MgO sample had a penetration of 34.7±0.1 mm, which also indicated no cohesion. After curing at 190° C. for 24-hours the penetration depth in the lower packed bed was 16.4±0.1 mm, signifying there is more resistance to penetration from the probe and there is better cohesion between the particles in the packed bed.

The examples given show the effects of one water scavenging additive. Others water scavenging additives will behave similarly and consume water at the reaction stoichiometric ratio and increase the volume based on the relative volume change during the reaction, effectively increasing the thermal conductivity of the packed bed of thermal enhancers.

### Aspects

The present disclosure will be better understood upon reading the following numbered aspects which should not be confused with the claims. In some instances, each of the aspects described below can be combined with other aspects, including combined with other aspects described elsewhere in the disclosure or other aspects from the examples below, without departing from the spirit of the disclosure.

1. A pumpable thermal reach enhancement (TRE) suspension that comprises a mixture comprising a plurality of suspended TRE particles, water, and a water scavenging additive; wherein the water scavenging additive is present in the mixture in an amount that allows for chemical consolidation of the mixture to form a partially dehydrated TRE sheath having a thermal conductivity of at least 1 W/mK; and wherein chemical consolidation comprises the water scavenging additive reacting with water in situ at a temperature above 50° C. to decrease porosity of the mixture and thereby form the partially dehydrated TRE sheath.

2. The suspension of aspect 1, wherein a weight ratio of the TRE particles to the water scavenging additive is between 10:1 and 1:1.

3. The suspension of any one of the preceding aspects, wherein the partially dehydrated TRE sheath has a thermal conductivity of between 1 W/mK and 150 W/mK and/or has a compressive strength of greater than 0.5 psi.

4. The suspension of any one of the preceding aspects, wherein the water scavenging additive reacts with water in situ at a temperature between 50° C. and 90° C.

5. The suspension of any one of the preceding aspects, wherein the TRE particles comprise a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy.

6. The suspension of any one of the preceding aspects, wherein the plurality of TRE particles have a shape selected from the group consisting of a platelet, a flake, a sphere, an irregular shape, a cube, a rod, and a disc.

7. The suspension of any one of the preceding aspects, wherein a first portion and a second portion of the plurality of TRE particles have a shape selected from the group consisting of a platelet, a flake, a sphere, an irregular shape, a cube, a rod, a disc, and wherein the shape of the first and second portions are distinct.

8. The suspension of any one of the preceding aspects, wherein the plurality of TRE particles have a composition and shape such that a mass of the first particles, upon dehydration, deforms elastically and plastically.

9. The suspension of any one of the preceding aspects, wherein the plurality of the TRE particles have a D50 particle size of between 5 μm and 5.0 mm, and/or wherein the plurality of TRE particles have a D50 particle size of between 0.01 μm and 50 mm.

10. The suspension of any one of the preceding aspects, wherein the water scavenging additive accounts for between 1 and 50 wt % of a total weight of the mixture.

11. The suspension of any one of the preceding aspects, wherein the water accounts for between 0.5 and 70 wt % of a total weight of the mixture prior to the water scavenging additive reacting with the water in situ.

12. The suspension of any one of the preceding aspects, wherein the water accounts for between 0.1 and 50 wt % of a total weight of the mixture after the water scavenging additive reacts with the water in situ.

13. The suspension of any one of the preceding aspects, wherein the water scavenging additive is an oxide or hydroxide particle selected from the group comprising magnesium oxide, titanium oxide, manganese oxide, iron oxide, copper oxide, aluminum oxide, periclase, lime, manganosite, bunsenite, zincite, bromellite, tenorite, brucite, portlandite, pyrochroite, theophrastite, sweetite, behoite, and spertiniite.

14. The suspension of any one of the preceding aspects, wherein the water scavenging additive is selected from a group containing organic, polymeric, dendritic, zeolites, natural materials, or carbon-based materials.

15. The suspension of any one of the preceding aspects, wherein the water scavenging additive is inorganic, a metal, a composite alloy, a mineral, or a ceramic.

16. The suspension of any one of the preceding aspects, wherein the water scavenging additive improves the packing efficiency of the TRE particles by at least 5%.

17. The suspension of any one of the preceding aspects, wherein the water scavenging additive reduces the fluidity of the TRE suspension

18. The suspension of any one of the preceding aspects, wherein the water scavenging additive imparts improved mechanical properties to the partially dehydrated TRE sheath.

19. The suspension of any one of the preceding aspects, wherein the partially dehydrated TRE sheath has a final porosity of equal or less than 70% and/or has a permeability of equal or less than 1 centiDarcy.

20. The suspension of any one of the preceding aspects, wherein the water further comprises a viscosity modifier.

21. The suspension of any one of the preceding aspects, wherein the viscosity modifier will break or thin in situ during heating at or above 90° C.

22. A pumpable thermal reach enhancement (TRE) suspension that comprises a mixture comprising a plurality of suspended TRE particles, water, and a gelling additive; wherein the gelling additive is present in the mixture in an amount that allows for gelation of the mixture to form a viscoplastic TRE sheath having a thermal conductivity of at least 1 W/mK; and wherein gelation comprises the gelling additive reacting with water in situ at a temperature above 50° C. to increase the yield point of the mixture and thereby form the viscoplastic TRE sheath.

23. The suspension of aspect 22, wherein a weight ratio of the TRE particles to the gelling additive is between 10:1 and 1:1.

24. The suspension of any one of aspects 22-23, wherein the viscoplastic TRE sheath has a thermal conductivity of between 1 W/mK and 150 W/mK and/or a compressive strength of at least 0.5 psi.

25. The suspension of any one of aspects 22-24, wherein the TRE particles comprise a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy.

26. The suspension of any one of aspects 22-25, wherein the plurality of TRE particles have a shape selected from the group consisting of a platelet, a flake, a sphere, an irregular shape, a cube, a rod, and a disc.

27. The suspension of any one of aspects 22-26, wherein a first portion and a second portion of the plurality of TRE particles have a shape selected from the group consisting of a platelet, a flake, a sphere, an irregular shape, a cube, a rod, a disc, and wherein the shape of the first and second portions are distinct.

28. The suspension of any one of aspects 22-27, wherein the plurality of TRE particles have a composition and shape such that a mass of the first particles, upon gelation, deforms elastically and plastically.

29. The suspension of any one of aspects 22-28, wherein the plurality of the TRE particles have a D50 particle size of between 5 μm and 5.0 mm, and/or wherein the plurality of TRE particles have a D50 particle size of between 0.01 μm and 50 mm.

30. The suspension of any one of aspects 22-29, wherein the gelling additive accounts for between 0.1 and 50 wt % of a total weight of the mixture.

31. The suspension of any one of aspects 22-30, wherein the water accounts for between 0.5 and 70 wt % of a total weight of the mixture prior to the gelling additive reacting with the water in situ.

32. The suspension of any one of aspects 22-31, wherein the gelling additive is an inorganic or polymeric gelling agent selected from the group consisting of bentonite, sepiolite, attapulgite, laponite, natural gelling polymers, modified natural polymers, synthetic polymers, and biopolymers.

33. A pumpable thermal reach enhancement (TRE) suspension that comprises a mixture comprising a plurality of suspended TRE particles, water, and a strengthening additive; wherein the strengthening additive is added to the mixture in an amount that allows for strengthening of the mixture to form a strengthened TRE sheath having a thermal conductivity of at least 1 W/mK and a compressive strength of at least 0.5 psi; and wherein strengthening comprises the strengthening additive reacting with water in situ at a temperature above 50° C. to increase compressive strength of the mixture and thereby for the strengthened TRE sheath.

34. The suspension of aspect 33, wherein the volume of the strengthening additive is less than the volume of the TRE particles.

35. The suspension of any one of aspects 33-34, wherein a weight ratio of the TRE particles to the strengthening additive is between 10:1 and 1:1.

36. The suspension of any one of aspects 33-35, wherein the strengthened TRE sheath has a thermal conductivity of between 1 W/mK and 150 W/mK.

37. The suspension of any one of aspects 33-36, wherein the strengthened TRE sheath has a compressive strength of between 0.5 psi and 500 psi.

38. The suspension of any one of aspects 33-37, wherein the TRE particles comprise a material selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy, and optionally wherein the TRE particles comprise at least two chemically distinct particles selected from the group consisting of zinc, graphite, graphene, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, carbon fiber, carbon black, and Hastelloy.

39. The suspension of any one of aspects 33-38, wherein the plurality of TRE particles have a shape selected from the group consisting of a platelet, a flake, a sphere, an irregular shape, a cube, a rod, and a disc.

40. The suspension of any one of aspects 33-39, wherein a first portion and a second portion of the plurality of TRE particles have a shape selected from the group consisting of a platelet, a flake, a sphere, an irregular shape, a cube, a rod, a disc, and wherein the shape of the first and second portions are distinct.

41. The suspension of any one of aspects 33-40, wherein the plurality of the TRE particles have a D50 particle size of between 5 μm and 5.0 mm, and/or wherein the plurality of TRE particles have a D50 particle size of between 0.01 μm and 50 mm.

42. The suspension of any one of aspects 33-41, wherein the strengthening additive accounts for between 0.5 and 50 wt % of a total weight of the mixture.

43. The suspension of any one of aspects 33-42, wherein the water accounts for between 0.5 and 70 wt % of a total weight of the mixture prior to the strengthening additive reacts with the water in situ.

44. The suspension of any one of aspects 33-43, wherein the water accounts for between 0.1 and 60 wt % of a total weight of the mixture after the strengthening additive reacts with the water in situ.

45. The suspension of any one of aspects 33-44, wherein the strengthening additive is an inorganic cement or organic resin.

46. The suspension of any one of aspects 33-45, wherein the strengthening additive improves the compressive strength of the TRE particles by at least 0.5 psi.

47. The suspension of any one of aspects 33-46, wherein the strengthening additive reduces the fluidity of the TRE suspension.

48. The suspension of any one of aspects 33-47, wherein the strengthening TRE sheath has a final porosity of equal or less than 70% and/or has a permeability of equal or less than 1 centiDarcy.

49. A method of placing a high-thermal reach enhancement (TRE) sheath around a closed-loop working fluid casing that is disposed in a wellbore at a target location within a geological formation that comprises pumping the suspension of any of aspects 1-48 into an annular space of the wellbore, wherein the annular space exists between the closed-loop working fluid casing and a wellbore wall at the target location; wherein the target location has a geostatic temperature sufficient for partial dehydration, gelation, or strengthening of the suspension; waiting for a time sufficient for partial dehydration, gelation, or strengthening of the suspension around the closed-loop working fluid casing to thereby form the TRE sheath.

50. The method of aspect 49, wherein the step of pumping the suspension and/or the step of waiting is sequentially performed until the TRE sheath covers at least 10% of a vertical height of the casing.

51. The method of any one of aspects 49-50, wherein the TRE sheath has a thermal conductivity of between 3 W/mK and 150 W/mK.

52. The method of any one of aspects 49-51, wherein the target location is at a depth of between 150 m and 20,000 m.

53. The method of any one of aspects 49-52, wherein the wellbore in the target location extends in a substantially vertical orientation.

54. The method of any one of aspects 49-53, wherein the target location has a geostatic temperature of between 120° C. and 600° C.

55. The method of any one of aspects 49-54, wherein the wellbore is located in a greenfield, in a brownfield, is a disused or abandoned oil well, or is a disused or abandoned gas well.

56. The method of any one of aspects 49-55, wherein the target location comprises hot dry igneous or metamorphous rock.

57. The method of any one of aspects 49-56, wherein the casing has a vertical length of between 10 m and 10,000 m.

58. The method of any one of aspects 49-57, wherein the TRE sheath is formed within 72 hours around the casing.

59. The method of any one of aspects 49-58, wherein the TRE sheath covers between 10% and 100% of a perimeter of the casing.

60. The method of any one of aspects 49-59, wherein the TRE sheath has a vertical length of between 5% and 100% of a total length of the casing.

61. The method of any one of aspects 49-60, wherein the target location further includes a plurality of thermal reach enhancement (TRE) structures that are at least partially filled with a high-thermal conductivity material, and wherein the high-thermal conductivity material in the TRE structures is thermally coupled with the TRE sheath in the wellbore.

62. The method of any one of aspects 49-61, wherein the TRE structures have a wedge-shaped configuration in which a mouth of the TRE structures is wider than a distal end of the TRE structures.

63. The method of any one of aspects 49-62, wherein the TRE structures are partially filled with the TRE sheath.

64. A system for heat transfer from a geological formation to a heat harvester casing, that comprises a heat harvester casing disposed in a wellbore that descends from a topside location to a target location in a geological formation; a chemically consolidated TRE sheath thermally coupling the casing to a wall of the wellbore; wherein the chemically consolidated TRE sheath comprises a plurality of TRE particles, water, and an additive; wherein the additive reacts with water in situ at a temperature above 50° C. to form the chemically consolidated TRE sheath; and wherein the TRE particles in the chemically consolidated TRE sheath form a contiguous network of compacted material thermally coupling the casing with a wall of the wellbore.

65. The system of aspect 64, wherein the chemically consolidated TRE sheath has a thermal conductivity of between 3 W/mK and 150 W/mK.

66. The system of any one of aspects 64-65, wherein the target location is at a depth of between 150 m and 20,000 m.

67. The system of any one of aspects 64-66, wherein the wellbore in the target location extends in a substantially vertical orientation.

68. The system of any one of aspects 64-67, wherein the target location has a geostatic temperature of between 120° C. and 600° C.

69. The system of any one of aspects 64-68, wherein the wellbore is located in a greenfield, in a brownfield, is a disused or abandoned oil well, or is a disused or abandoned gas well.

70. The system of any one of aspects 64-69, wherein the target location comprises hot dry igneous or metamorphous rock.

71. The system of any one of aspects 64-70, wherein the target location further includes a plurality of thermal reach enhancement (TRE) structures that are at least partially filled with a first high-thermal conductivity material, and wherein the high-thermal conductivity material in the TRE structures is thermally coupled with the partially dehydrated TRE sheath in the wellbore.

72. The system of any one of aspects 64-71, wherein the TRE structures extend from the wellbore distally into the geological formation at the target location.

73. The system of any one of aspects 64-72, wherein the TRE structures extend from the wall of the wellbore at least 1 m into the target location.

74. The system of any one of aspects 64-73, wherein the TRE structures have a wedge-shaped configuration in which a mouth of the TRE structures is wider than a distal end of the TRE structures.

75. The system of any one of aspects 64-74, wherein the TRE structures are partially filled with the partially dehydrated TRE sheath.

76. The system of any one of aspects 64-75, wherein the additive comprises at least one of a water scavenging additive, a gelling additive, and a strengthening additive.

77. The system of any one of aspects 64-76, wherein the additive comprises at least two of a water scavenging additive, a gelling additive, and a strengthening additive.

78. The system of any one of aspects 64-77, wherein the chemically consolidated TRE sheath has a compressive strength of at least 0.5 psi.

79. The system of any one of aspects 64-75, wherein the additive performs at least two functions selected form the group consisting of water scavenging additive, gelling additive, and strengthening.

80. A pumpable thermal reach enhancement (TRE) suspension, comprising: an aqueous high apparent viscosity slurry that includes a plurality of TRE particles and a heat-activated consolidating additive; wherein the high apparent viscosity slurry has a composition that allows a reduction of viscosity via an increase in temperature or via a chemical reaction; and wherein the heat-activated consolidating additive has a composition that above a threshold temperature reacts with water to consume water and/or physically expand; and wherein the TRE particles are present in the suspension in a larger weight percentage or volume fraction than the heat-activated consolidating additive.

81. The pumpable TRE suspension of aspect 80, wherein the plurality of TRE particles comprise a material selected from the group consisting of zinc, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, graphite, graphene, carbon fiber, carbon black, and Hastelloy.

82. The pumpable TRE suspension of aspect 80, wherein the aqueous high apparent viscosity slurry comprises a thermosensitive viscosity agent, and wherein a viscosity of the aqueous high apparent viscosity slurry declines at a temperature above 100° C.

83. The pumpable TRE suspension of any one of aspects 80-82, wherein the heat-activated consolidating additive comprises a water scavenging additive.

84. The pumpable TRE suspension of aspect 83, wherein the water scavenging additive comprises a metal oxide.

85. The pumpable TRE suspension of any one of aspects 80-82, wherein the heat-activated consolidating additive comprises a gelling additive.

86. The pumpable TRE suspension of aspect 86, wherein the gelling additive comprises a synthetic polymer.

87. The pumpable TRE suspension of any one of aspects 80-82, wherein the heat-activated consolidating additive comprises a strengthening additive.

88. The pumpable TRE suspension of aspect 87, wherein the strengthening additive comprises a cementitious material.

89. The pumpable TRE suspension of aspect 80, wherein a weight or volume ration of the TRE particles to the heat-activated consolidating additive is between 10:1 and 1:1.

90. A method of forming at a target location a TRE sheath in an annular space between a wall of a geothermal well and a casing of a heat harvesting element, comprising: pumping a TRE suspension according to any one of aspects 80-90 into the annular space; allowing to settle the TRE particles in the target location upon reduction of viscosity of the aqueous high apparent viscosity slurry; allowing the heat-activated consolidating additive at the target location to react with water thereby reduce porosity of the settled TRE particles.

91. The method of aspect 90, wherein the viscosity is reduced at the target location due to thermal instability of a viscosity agent in the aqueous high apparent viscosity slurry.

92. The method of aspect 91, wherein a temperature at the target location is at least 150° C., and wherein the target location is at a depth of at least 150 m below ground.

93. The method of aspect 90, wherein the aqueous high apparent viscosity slurry comprises a synthetic polymeric viscosity agent.

94. The method of aspect 90, wherein the TRE particles comprise a material selected from the group consisting of zinc, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, graphite, graphene, carbon fiber, carbon black, and Hastelloy.

95. The method of aspect 90, wherein the heat-activated consolidating additive comprises a water scavenging additive.

96. The method of aspect 90, wherein the heat-activated consolidating additive comprises a gelling additive.

97. The method of aspect 90, wherein the heat-activated consolidating additive comprises a strengthening additive.

98. The method of aspect 90, wherein the TRE sheath is produced in multiple successive rounds of the steps of pumping, allowing to settle, and allowing to react.

99. The method of aspect 90, wherein the heat-activated consolidating additive expands or swells upon reaction with water, thereby increasing contact and/or thermal energy transfer among the TRE particles.

In some embodiments, the numbers expressing quantities of ingredients, properties such as concentration, reaction conditions, and so forth, used to describe and claim certain embodiments of the invention are to be understood as being modified in some instances by the term “about.” As used herein, the terms “about” and “approximately”, when referring to a specified, measurable value (such as a parameter, an amount, a temporal duration, and the like), is meant to encompass the specified value and variations of and from the specified value, such as variations of +/−10% or less, alternatively+/−5% or less, alternatively+/−1% or less, alternatively+/−0.1% or less of and from the specified value, insofar as such variations are appropriate to perform in the disclosed embodiments. Thus, the value to which the modifier “about” or “approximately” refers is itself also specifically disclosed. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A pumpable thermal reach enhancement (TRE) suspension, comprising:
an aqueous high apparent viscosity slurry that includes a plurality of TRE particles and a heat-activated consolidating additive;
wherein the high apparent viscosity slurry has a composition that allows a reduction of viscosity via an increase in temperature or via a chemical reaction; and
wherein the heat-activated consolidating additive has a composition that above a threshold temperature reacts with water to consume water and/or physically expand; and
wherein the TRE particles are present in the suspension in a larger weight percentage or volume fraction than the heat-activated consolidating additive.

2. The pumpable TRE suspension of claim 1, wherein the plurality of TRE particles comprise a material selected from the group consisting of zinc, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, graphite, graphene, carbon fiber, carbon black, and Hastelloy.

3. The pumpable TRE suspension of claim 1, wherein the aqueous high apparent viscosity slurry comprises a thermosensitive viscosity agent, and wherein a viscosity of the aqueous high apparent viscosity slurry declines at a temperature above 100° C.

4. The pumpable TRE suspension of claim 1, wherein the heat-activated consolidating additive comprises a water scavenging additive.

5. The pumpable TRE suspension of claim 4, wherein the water scavenging additive comprises a metal oxide.

6. The pumpable TRE suspension of claim 1, wherein the heat-activated consolidating additive comprises a gelling additive.

7. The pumpable TRE suspension of claim 6, wherein the gelling additive comprises a synthetic polymer.

8. The pumpable TRE suspension of claim 1, wherein the heat-activated consolidating additive comprises a strengthening additive.

9. The pumpable TRE suspension of claim 8, wherein the strengthening additive comprises a cementitious material.

10. The pumpable TRE suspension of claim 1, wherein a weight or volume ration of the TRE particles to the heat-activated consolidating additive is between 10:1 and 1:1.

11. A pumpable thermal reach enhancement (TRE) suspension, comprising:
a mixture comprising a plurality of suspended TRE particles, water, and a water scavenging additive;
wherein the water scavenging additive is present in the mixture in an amount that allows for chemical consolidation of the mixture to form a partially dehydrated TRE sheath having a thermal conductivity of at least 1 W/mK; and
wherein chemical consolidation comprises the water scavenging additive reacting with water in situ at a temperature above 50° C. to decrease porosity of the mixture and thereby form the partially dehydrated TRE sheath.

12. The suspension of claim 11, wherein the water further comprises a viscosity modifier that will break or thin in situ at a temperature that is lower than a temperature at which the water scavenging additive reacting with water in situ.

13. The suspension of claim 11, wherein a weight ratio of the TRE particles to the water scavenging additive is between 10:1 and 1:1, and/or wherein the water scavenging additive accounts for between 0.5 and 50 wt % of a total weight of the mixture.

14. The suspension of claim 11, wherein the water scavenging additive improves the packing efficiency of the TRE particles by at least 5%, and/or wherein the partially dehydrated TRE sheath has a final porosity of equal or less than 70% and/or has a permeability of equal or less than 1 centiDarcy.

15. A method of forming at a target location a TRE sheath in an annular space between a wall of a geothermal well and a casing of a heat harvesting element, comprising:
pumping a TRE suspension into the annular space;
wherein the TRE suspension comprises
(a) an aqueous high apparent viscosity slurry that includes a plurality of TRE particles and a heat-activated consolidating additive;
wherein the high apparent viscosity slurry has a composition that allows a reduction of viscosity via an increase in temperature or via a chemical reaction; and
wherein the heat-activated consolidating additive has a composition that above a threshold temperature reacts with water to consume water and/or physically expand; and
wherein the TRE particles are present in the suspension in a larger weight percentage or volume fraction than the heat-activated consolidating additive;
or
(b) a mixture comprising a plurality of suspended TRE particles, water, and a water scavenging additive;
wherein the water scavenging additive is present in the mixture in an amount that allows for chemical consolidation of the mixture to form a partially dehydrated TRE sheath having a thermal conductivity of at least 1 W/mK; and
wherein chemical consolidation comprises the water scavenging additive reacting with water in situ at a temperature above 50° C. to decrease porosity of the mixture and thereby form the partially dehydrated TRE sheath;
allowing to settle the TRE particles in the target location upon reduction of viscosity of the aqueous high apparent viscosity slurry;
allowing the heat-activated consolidating additive at the target location to react with water thereby reduce porosity of the settled TRE particles.

16. The method of claim 15, wherein the viscosity is reduced at the target location due to thermal instability of a viscosity agent in the aqueous high apparent viscosity slurry, and optionally wherein a temperature at the target location is at least 150° C., and wherein the target location is at a depth of at least 150 m below ground.

17. The method of claim 15, wherein the heat-activated consolidating additive expands or swells upon reaction with water, thereby increasing contact and/or thermal energy transfer among the TRE particles.

18. The method of claim 15, wherein the aqueous high apparent viscosity slurry comprises a synthetic polymeric viscosity agent, and/or wherein the TRE particles comprise a material selected from the group consisting of zinc, tungsten, aluminum, silicon carbide, aluminum nitride, silicon nitride, boron nitride, gold, copper, silver, diamond, aluminum alloys, aluminum oxides, rhodium, zinc, cobalt, copper alloys, nickel, iron, platinum, palladium, tin, steel, zirconium, titanium, graphite, graphene, carbon fiber, carbon black, and Hastelloy.

19. The method of claim 15, wherein the heat-activated consolidating additive comprises a water scavenging additive, a gelling additive, and/or a strengthening additive.

20. The method of claim 15, wherein the TRE sheath is produced in multiple successive rounds of the steps of pumping, allowing to settle, and allowing to react.
